(19) United States
(12) Patent Application Publication
(10) Pub. No.: US 2008/0129671 A1
(43) Pub. Date: Jun. 5, 2008

(54) COLOR DISPLAY SYSTEM

(75) Inventors: Yuhren Shen, Taipei (TW); Hanjon Ho, Kaohsiung (TW); Chang Cheng Lin, Taipei (TW); Cheng Jung Chen, MiaoliHsien (TW)

Correspondence Address: LOWE HAUPTMAN HAM & BERNER, LLP, 1700 DIAGONAL ROAD, SUITE 300, ALEXANDRIA, VA, 22314, US

(73) Assignee: VastView Technology, Inc.

(21) Appl. No.: 11/967,147

(22) Filed: Dec. 29, 2007

Related U.S. Application Data
(63) Continuation-in-part of application No. 10/965,808, filed on Oct. 18, 2004.

(51) Int. Cl. G09G 3/36

(52) U.S. Cl. 345/88

(57) ABSTRACT

A color display system comprises a color signal source, a buffer unit, a storage unit, a recovering module, a comprising unit, and a multi-functional comparing unit. The multi-functional comparing unit is used for comparing a recovered OD value of the recovering module, a grayscale of the color signal source, and a comparison result of the comparing unit are compared and then outputs a result of either the grayscale of the current frame or the recovered OD value. By this way, the color display system can respond to display grayscales of colors fast and accurately. The color display system is suitable for a liquid crystal display (LCD), a plasma display panel (PDP), a thin film transistor (TFT), an organic electro luminescence display (OLED), and a polymer light emitting diode (PLED).

### CROSS-REFERENCE TO RELATED DOCUMENTS

The present invention is a continuation in part (CIP) to a U.S. patent application Ser. No. 10/965,808 entitled “Color Display System” filed on Oct. 18, 2004.

### BACKGROUND OF THE INVENTION

1. Field of the Invention

The present invention is related to a color display system, especially to a color display system that can compare grayscales of the proceeding frame and the current frame and then determine whether it needs to add a recovered OD (Over Driving) value or not when displaying. The color display system therefore can display an image faster and more accurately for applications in various color display devices.

2. Description of the Prior Art

Response time is an important parameter for evaluating the characteristics of a liquid crystal display (LCD) panel. A LCD panel can be operated in two different modes, i.e. a Normally White (NW) mode and a Normally Black (NB) mode. When bias voltages are not applied, a LCD panel will show a bright image under the NW mode and a dark image under the NB mode. For the NW mode, as an example, the response time is determined by the following two components:
(1) Rising response time (Tᵣ): time for twisting liquid crystal of a LCD cell gap from 90 percent to 10 percent luminance when voltage is applied.
(2) Falling response time (T_{f}): time for twisting liquid crystal of a LCD cell gap from 10 percent to 90 percent luminance, even no adding voltage.

Although displaying more than 25 frames per second is fast enough for human eyes to see a continuous video, the demand of visual entertainments nowadays is much more than that. For example, when people play a DVD (Digital Video Display) player or a Play station, the display speed is usually more than 60 frames per second, corresponding to a frame interval of only 16.67 ms or even shorter. If the response time of a LCD is longer than the frame interval time, the desired brightness of each pixel of the LCD cannot be reached, resulting in afterimage and blurred image when displaying a high-speed moving object.

The response time is determined by the inherent property of the liquid crystal molecule, such viscosity, dielectric and elastic constants. On the other hands, it also depends on the design of LCD panel, such as the thickness of the gap between two electrodes. The rise time (Tᵣ) and fall time (T_{f}) are given by

$${T}_{r} = \frac{{r}_{1} {d}^{2}}{Δɛ ( {V}^{2} - {V}_{th}^{2} )}$$

$${T}_{f} = \frac{{r}_{1} {d}^{2}}{Δɛ {V}_{th}^{2}}$$

γ₁: rotational viscosity of liquid crystal material

d: cell gap

V: driving voltage

Δ∈: dielectric anisotropy

Hence, the good solution has four ways: smaller rotational viscosity, smaller cell gap, larger driving voltage, and larger dielectric anisotropy. The way of using a larger driving voltage is called Over Drive (OD) technique, which is giving a higher voltage to enforce liquid-crystal molecules to be twisted earlier, and hence responded faster for satisfying the demand grayscale of image data.

For 8-bits RGB color signals (R for red, G for Green, and B for blue) with 256 grayscales, it is necessary to apply an appropriate OD voltage for each color at a given grayscale. However, the OD voltage will be different for each color at a given grayscale level changing to another level. This means that it requires 256×256=65536 different OD values for a given color to change from one grayscale level to another. For RGB colors, a total of 3×65536 different OD values must be stored in the memory, which not only increases the loading of the memory, but also the overall cost of the LCD.

To reduce memory loadings, a conventional method to solve this problem is to reduce number of original OD values. This can be done by reducing the original OD table, which is a table of 256×256 elements (original OD table), into a smaller table, for example, of 32×32 elements (shrunk OD table). The OD values of the original OD table were then recovered from the elements of the shrunk OD table by using approximated functions. The functions can be polynomial, bilinear, or liner combination of orthogonal functions. However, the original OD values are difficult to recover accurately from the elements of a shrunk OD table via such numerical schemes, which critically affects the response time/speed as well as the color display will be affected critically. In addition, when the demanded grayscale has been achieved, further use of the OD value will degrade the color display. In view of the above mentioned deficiencies, the present invention provides a color display system using a faster and more accurate signal processing method for enhancing the grayscale response speed of a panel by a experimentally determined shrunk OD table and then recovering the original OD values via numerical schemes. The inventors provide the present invention according to academic research and design as well as improvement in experiments.

### SUMMARY OF THE INVENTION

The primary object of the present invention is to provide a color display system that is able to respond faster and more accurately by using or not an OD value, depending on the result of comparing the grayscales of the preceding frame and the current frame. In order to achieve the above object, the present invention provides a color display system comprising a color signal source, for providing a color signal of a current frame, a buffer unit for temporarily saving the grayscale of a preceding frame of a color display system, a storage unit for saving shrunk OD tables, a recovering module for recovering OD values, including a selecting unit, a calculating unit, and a recovering unit; a comparing unit, and a multi-functional comparing unit.

The color display system comprising the steps of:
(1) Inputting a grayscale of a preceding frame from the buffer unit to the recovering module, and inputting a grayscale of a current frame from the color signal source to the comparing unit,
(2) The selecting unit selecting some specific OD values from the shrunk OD tables, P, Q, R, and S by referencing the grayscales of the preceding frame and the current frame to build grayscale functions g₁(y), g₂(Y), h₁(x) and h₂(x), calculating the grayscale functions by the calculating unit to develop grayscale function g(y) and h(x), then the recovering unit recovering the original QD value via the function

f(x,y)=c×h(x)×g(y);
(3) The comparing unit comparing the grayscales of the preceding frame and the current frame, if the grayscales being the same or nearly the same, the submit a signal of OD free hence the overdriving will not be performed, and
(4) The recovered OD values, the grayscale of the current frame, the signal for OD free can being inputting into the multi-functional comparing unit, if the multi-functional comparing unit get the signal of OD free, it submitting the grayscale of the current frame, if not submitting the recovered OD value.

The present invention will be more apparent after reading the detailed description of the preferred embodiments thereof in reference to the accompanying drawings.

### BRIEF DESCRIPTION OF THE DRAWINGS

FIG. 1 shows a first embodiment of a color display system of the present invention.

FIG. 2 shows a second embodiment of a color display system of the present invention.

FIG. 3 is a table of measured OD values according to the present invention.

FIG. 4 is a look-up table according to the present invention.

FIGS. 5A-D are tables of shrunk OD values according to the present invention.

### DETAILED DESCRIPTION OF THE PREFERRED EMBODIMENT

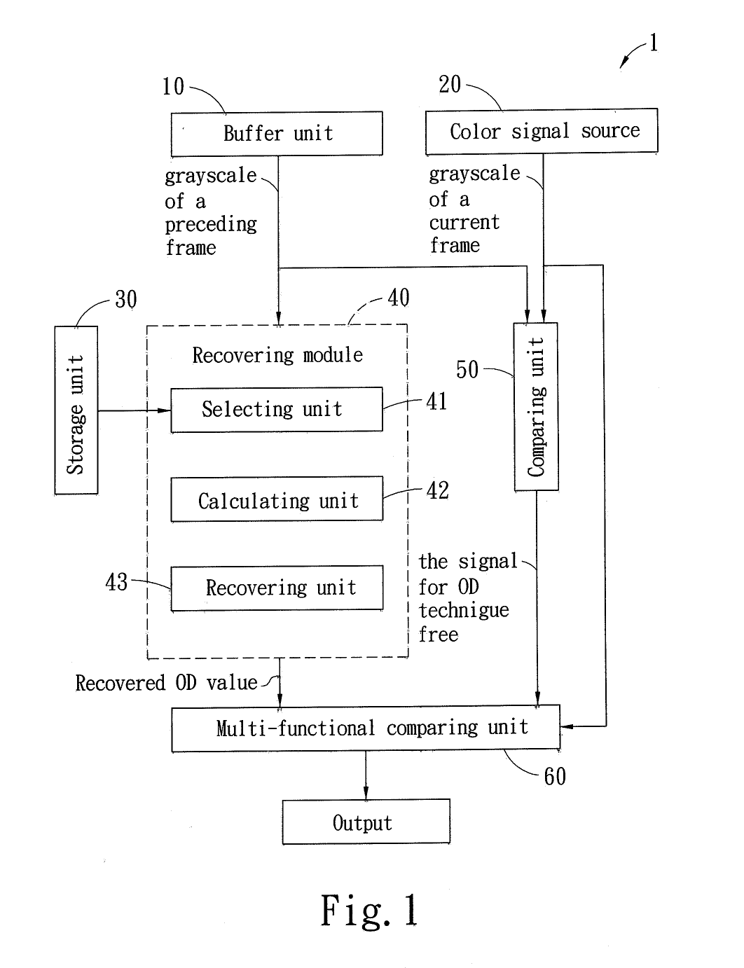

As shown in FIG. 1, a color display system according to the present invention comprises a buffer unit 10, a color signal source 20, a storage unit 30, a recovering module 40, a comparing unit 50, and a multi-functional comparing unit 60. The recovering module 40 includes a selecting unit 41, a calculating unit 42, and a recovering unit 43.

The buffer unit 10 is used for temporarily saving a grayscale of a preceding frame of a color display system. The color signal source 20 is used for providing color signals of the current frame having a grayscale. The storage unit 30 is used for saving shrunk OD tables. The recovering module 40 is used for recovering OD values, wherein the selecting unit 41 is for selecting some specific shrunk OD values from the shrunk OD tables by referencing the grayscales of the preceding frame and the current frame to build first grayscale functions, the calculating unit 42 is for calculating the first grayscale functions to develop second grayscale functions and the recovering unit 43 is for recovering a recovered OD value with a third function. The comparing unit 50 is used for comparing the grayscales of the preceding frame and the current frame. If the grayscales are the same or nearly the same, the comparing unit will submit a signal for OD technique free to a multi-functional comparing unit 60 that is used for receiving the recovered OD value, the grayscale of the current frame, and the signal for OD technique free. If the multi-functional comparing unit 60 receives the signal for OD technique free from the comparing unit 50, it will output the grayscale of the current frame. If not, it will output the recovered OD value.

In practice, a grayscale of a preceding frame is input from the buffer unit 10 to the recovering module 40 and the comparing unit 50 while a grayscale of a current frame is input from the color signal source 20 to the comparing unit 50 and the multi-functional comparing unit 60. It should be noted that the current frame is after the preceding frame. Then the selecting unit 41 selects some specific shrunk OD values from the shrunk OD tables P, Q, R, and S by referencing the grayscales of the preceding frame and the current frame to build first grayscale functions, that is, grayscale functions g₁(y), g₂(y) h₁(x), and h₂(x). Then the first grayscale functions are calculated by the calculating unit 42 to develop second grayscale functions g(y) and h(x). A recovered OD value is obtained via the recovering unit 43 by using a third function, f(x, y)=c×h(x)×g(y).

Then, the comparing unit 50 compares the grayscales of the preceding frame and the current frame. If the grayscales are the same or nearly the same, the comparing unit 50 will submit a signal for OD technique free to the multi-functional comparing unit 60. If the multi-functional comparing unit 60 receives the signal for OD technique free, it will output the grayscale of the current frame. If not, the multi-functional comparing unit 60 will output the recovered OD value. The recovered OD value output from the multi-functional comparing unit can be output to a panel, driver, or T-con (Timing Controller). Besides, the color display system according to the present invention can be a Liquid Crystal Display, a Plasma Display Panel, a Thin Film Transistor, an Organic Electro Luminescence Display, or a Polymer Light Emitting Diode.

Moreover, the color signal in the color display system according to the present invention is at least one of 8-bit red, green, and blue color signals (R, G, B).

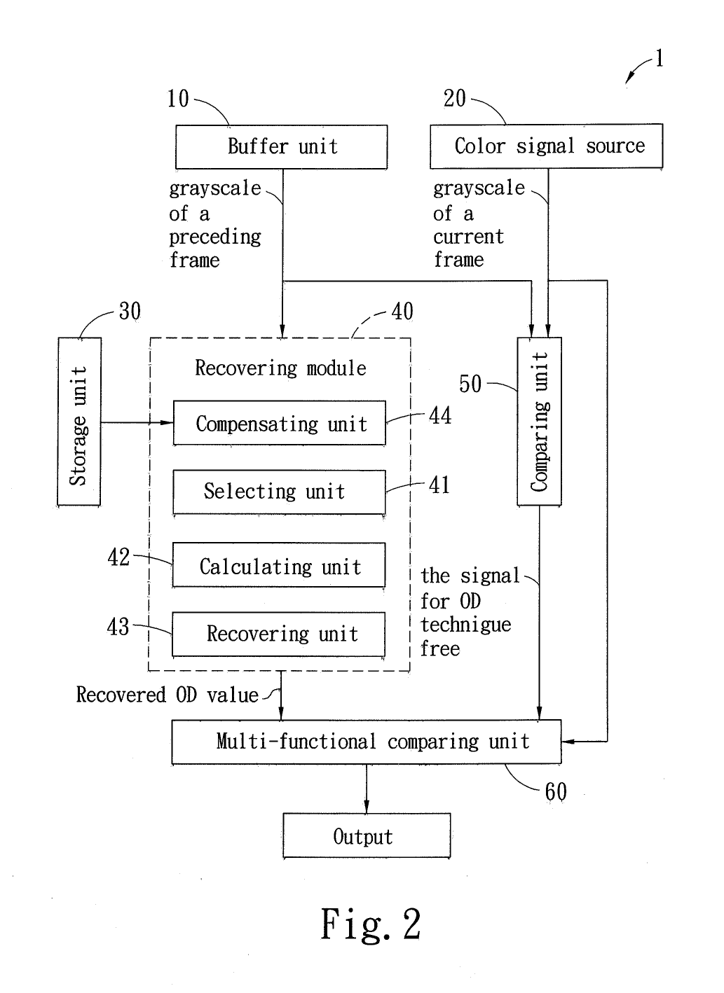

Furthermore, refer to FIG. 2 that shows a second embodiment of a color display system according to the present invention. In this embodiment, the recovering module 40 further includes a compensating unit 44 and the storage unit 30 further has shrunk OD value tables P₁-P_{N}′Q₁-Q_{N}′R₁-R_{N} and S₁-S_{N}, where N is the sum number of the tables. These shrunk OD value tables are dependent on temperature.

When in practice, a grayscale of a preceding frame is input from the buffer unit 10 to the recovering module 40 and the comparing unit 50 while a grayscale of a current frame is input from the color signal source 20 to the comparing unit 50 and the multi-functional comparing unit 60. It should be noted that the current frame is after the preceding frame. For different temperature demands, the compensating unit 44 chooses specific shrunk OD value tables P₂′Q₂′R₂ and S₂ from the shrunk OD value tables P₁-P_{N}′Q₁-Q_{N}′R₁-R_{N} and S₁-S_{N} in the storage unit 30.

Then the selecting unit 41 collects some specific shrunk OD values from the shrunk OD value tables P, Q, R, and S by referencing the grayscales of the preceding frame and the current frame to build first grayscale functions, that is, grayscale functions g₁(y), g₂(y) h₁(x), and h₂(x). Then the first grayscale functions are calculated by the calculating unit 42 to develop second grayscale functions g(y) and h(x). A recovered OD value is obtained via the recovering unit 43 by using a third function, f(x, y)=c×h (x)×g(y).

Then, the comparing unit 50 compares the grayscales of the preceding frame and the current frame. If the grayscales are the same or nearly the same, for example, the error range between the preceding frame and the current frame is less than 5 grayscales, the comparing unit 50 will submit a signal for OD technique free to the multi-functional comparing unit 60. If the multi-functional comparing unit 60 receives the signal for OD technique free, it will output the grayscale of the current frame. If not, the multi-functional comparing unit 60 will output the recovered OD value.

By this way, the color display system 1 can be used under different temperatures in different places, latitudes, and working environments in addition to displaying faster and more accurately different places.

Finally, for convenience, a red-color gray scale of 5-bit signals is taken as an example in the following to show how a signal is processed in the color display system of the present invention. The description in the following is only an embodiment for illustrating the present invention instead of giving any limitation to the scope of the present invention.

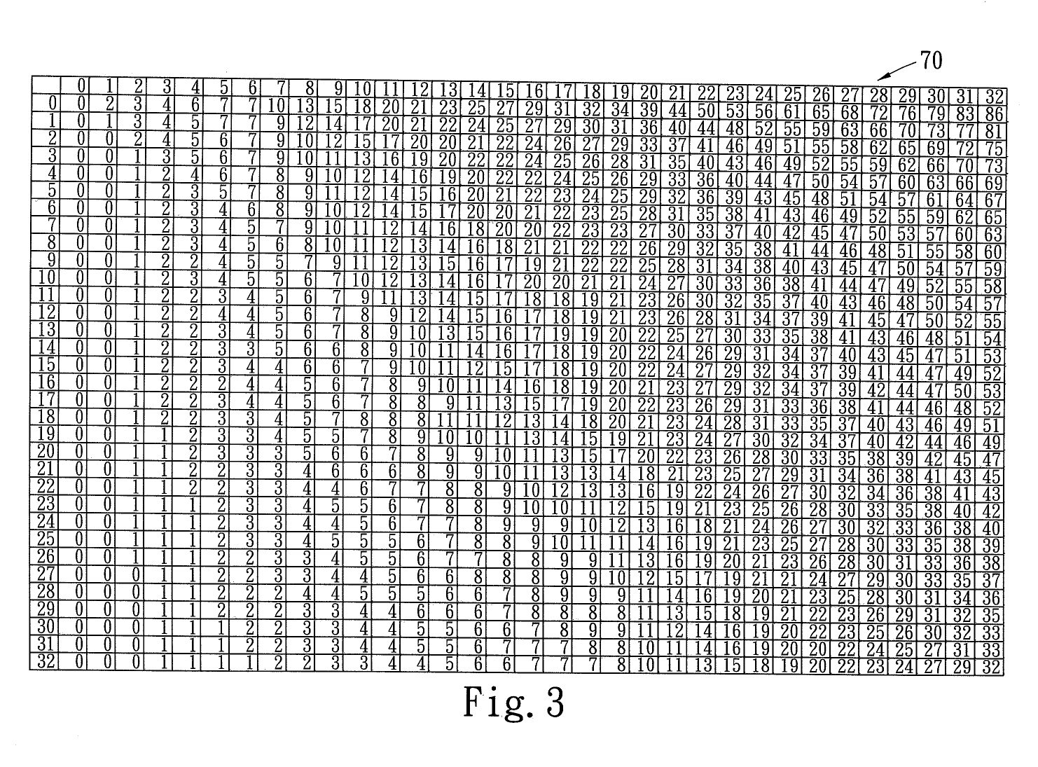

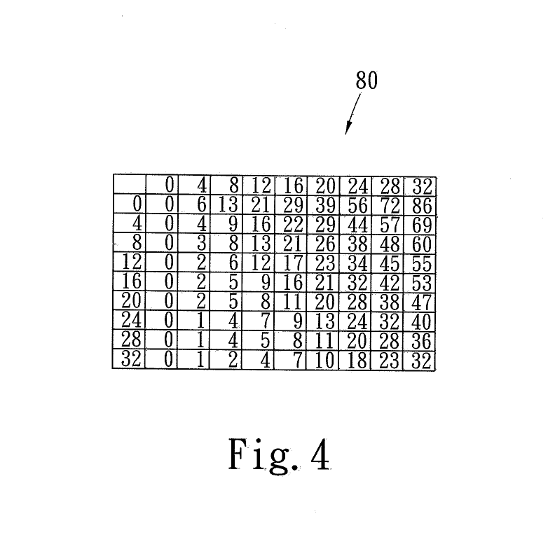

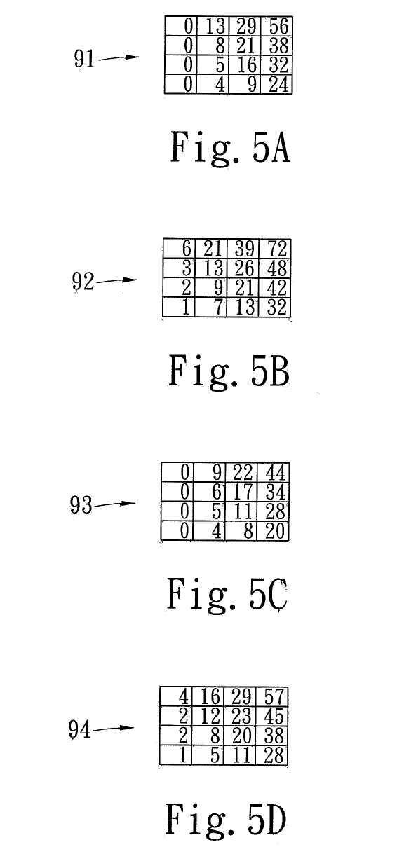

Refer to FIGS. 3, 4, and 5A-5D. The best OD voltage values in corresponding to all red-color gray scales of brightness on the liquid crystal screen are measured in advance. Then find the best OD voltage values for displaying desired grayscales of brightness by the practical measuring mode according to the characteristic of liquid crystals. The best OD voltage value has one-on-one relationship with the grayscale value presented by a preceding frame and the grayscale value presented by a proper current frame respectively. Thereby, an n×n array N can be built by the measurement, where the total amount of grayscales “n” is equal to 32. The array N is also called a table 70 of measured OD values. For example, when the grayscale value of the preceding frame is 16, and the grayscale value of the current frame is 26, the corresponding measured OD value is N_{16,26}.

After that, build a functional relationship between the OD values and the grayscale values in order to simulate the relationship between an OD value and the grayscale value of a preceding frame and the grayscale value of a proper current frame. Let x represent the grayscale value of the proper current frame and y represent the grayscale value of the former frame, and a functional relationship f(x,y) between N_{yx} and x, y can be built. For example, when the grayscale value of the preceding frame is 16, a result f(x,16)=b×h₁₆(x) can be obtained by simulation according to the measured values N_{16,1}, N_{16,2}, . . . , N_{16,32}. Or, when the grayscale value of the proper current frame is 26, a result f(26,y)=a×g₂₆(Y) can be obtained by simulation according to the measured values N_{1,26}, N_{2,26}, . . . , N_{32,26}. Therefore, all the functional relationships between OD values and x, y can be built by means of the value simulation.

In other words, N_{yx}=f(x,y)=c×h_{y}(x)×gₓ(y), wherein C is normalization constant and h_{y}(x) and gₓ(y) are mathematical functions. These functions can be of any type of a polynomial, a bilinear relationship, a linear combination of orthogonal functions or any type of mathematical function.

Then, shrink the measured OD values of the table 70 and store the shrunk OD values in a look-up table (LUT) 80. Pick and shrink the measured OD values of the table 70 to form an m×m array M, where m<n. A grayscale of 5-bit signals is taken as an example. A table 70 of 32×32 measured OD values is shrunk to form an 8×8 OD look-up table 80. The mode of picking and shrinking can be an equal-space picking method. For example, in the array N, an element is picked from every four elements to form an array M, i.e., Mᵢⱼ=N_{8i-7,8j-7}, wherein i, j=1, 2 . . . m, indicating the corresponding positions of the matrix elements in the matrix. In practical application, the mode of picking and shrinking is not limited to the equal-space picking method. If it is found in actual measuring that variation rates of some OD values are larger, a non equal-space picking method can be used so long that the relative positions for picking are remembered.

Then, the look-up table 80 is made to get the best recovered OD values by using the mathematical function having been built. Utilize the built mathematical function and adopt a four-point positioning method to acquire the best recovered OD values in a way of curve fitting and to drive a display with the recovered OD values. The four-point positioning method adopted in the present invention further severs the OD look-up table 80 into four tables 91-94 of shrunk values. They are respectively P91, Q92, R93 and S94. The mutually corresponding relationship between the elements in the four tables 91-94 of shrunk values and the elements in the OD look-up table 80 can be expressed as below.

Pₖ₁M_{2k-1,21-1}

Qₖ₁M_{2k,21-1}

Rₖ₁M_{2k-1,21}

Sₖ₁M_{2k,21,}

wherein k, 1=1,2 . . . m/2, which indicates the corresponding positions of the elements in the matrix. In other words, in the OD look-up table 80, the four neighboring elements can be expressed by using the corresponding elements of P91, Q92, R93 and S94. Namely:

$$[ \begin{matrix}{M}_{i + j} {M}_{i , j + 1} \\ {M}_{i + 1 , j} {M}_{i + 1 , j + 1}\end{matrix} ] ≡ [ \begin{matrix}{P}_{kl} {R}_{kl} \\ {Q}_{kl} {S}_{kl}\end{matrix} ]$$

where i, j are odd integers, and k=(i+1)/2, 1=(j+1)/2. Thereby, Pₖ₁ and Qₖₗ as well as Rₖ₁ and Sₖ₁ have respectively functional relationships of gⱼ(y) and gⱼ₊₁(y) respectively, while the Pₖ₁ and Rₖ₁ as well as Qₖ₁ and Sₖ₁ have functional relationships of hᵢ(x) and hᵢ₊₁(y) respectively.

When the grayscale of brightness of a preceding frame on the liquid crystal screen is y and the desired grayscale of brightness of a current frame is x, Pₖ₁,Qₖ₁, Rₖ₁ and Sₖ₁ neighboring with (x,y) are found out through the four tables 91-94 of shrunk values, and the best recovered OD values can be obtained by the way of curve fitting or by the way of weighted curve fitting according to the corresponding functional relationships of gⱼ(y), gⱼ₊₁(y), hᵢ(x) and hᵢ₊₁(y). The best recovered OD values activate the liquid crystal screen to make the latter accurately present the desired brightness.

Therefore, the present invention has the following advantages:
1. Accelerating the grayscale response speed: the recovered OD values of the present invention are obtained by calculating shrunk OD values that are shrunk from measured OD values, so that the present invention does no need to download and check every real OD value.
2. More accurately displaying: the way of getting recovered OD values of the present invention is mentioned above and the recovered OD values are nearly the same as real measured OD values. That makes the present invention can more accurately display.
3. Saving hardware resource for memory: that is because of the space for storing the recovered OD values of the present invention is smaller than the space for storing measured OD values.
4. Wider temperature range of working places: because the space needed for storing recovered OD values is reduced, different recovered OD value tables that are able to satisfy different using demands in different places, latitudes, and working environments can be included.

In conclusion, according to the description disclosed above, the present invention surely can achieve the expected object thereof to provide a faster and more accurate responding and displaying color display system for various color display devices. It is new and can be put into industrial use.

It should be understood that different modifications and variations could be made from the disclosures of the present invention by the people familiar in the art, which should be deemed without departing the spirit of the present invention.

What is claim is:

1. A color display system, comprising:
a color signal source for providing a color signal that is a current frame having a grayscale;
a buffer unit for temporary saving a grayscale of a preceding frame of a color display system;
a storage unit for saving shrunk OD values of shrunk OD (Over Driving) tables;
a recovering module for recovering OD values, including a selecting unit, a calculating unit, and a recovering unit, where the selecting unit is for selecting some specific shrunk OD values from the shrunk OD tables by referencing the grayscales of the preceding frame and the current frame to build first grayscale functions, the calculating unit is for calculating the first grayscale functions to develop second grayscale functions; the recovering unit is for recovering and getting a recovered OD value with a third function;
a comparing unit for comparing the grayscales of the preceding frame and the current frame, where if the grayscales are the same or nearly the same, the comparing unit will submit a signal for OD technique free; and
a multi-functional comparing unit is for receiving the recovered OD value, the grayscale of the current frame, and the signal for OD technique free, where if the multi-functional comparing unit receives the signal for OD technique free, it will output the grayscale of the current frame; if not, it will output the recovered OD value.

2. The color display system as in claim 1, wherein each shrunk OD value table further includes a plurality of shrunk OD value sub-tables that are dependent on temperature.

3. The color display system as in claim 2, wherein said recovering module further includes a compensating unit for choosing some specific shrunk OD value sub-tables from the shrunk OD value tables depends on different temperature values and inputting them to the selecting unit.

4. The color display system as in claim 1, wherein the third function is of polynomial, bilinear, or liner combination of orthogonal functions.

5. The color display system as in claim 1, wherein said color signal is at least one of 8-bit red, green, and blue color signals (R, (B).

6. The color display system as in claim 1, wherein the recovered OD value from the multi-functional comparing unit is output to a panel, driver, or T-con (Timing Controller).

7. The color display system as in claim 1, wherein the system is a liquid crystal display, a plasma display panel, a thin film transistor, an organic electro luminescence display, or a polymer light emitting diode.
